(19) United States
(12) Patent Application Publication
(10) Pub. No.: US 2026/0185672 A1
(43) Pub. Date: Jul. 2, 2026

(54) LIGHTING DEVICE HAVING A LIGHTING MODULE WITH A FLEXIBLE GUIDE SHEET AND ARRANGED IN FRONT OF AN ILLUMINATION MODULE

(71) Applicant: VALEO VISION, Bobigny (FR)

(72) Inventors: Sidahmed BEDDAR, Bobigny (FR); Eduardo ALVEAR, Bobigny (FR); Hafid EL-IDRISSI, Bobigny (FR); Benoit DELANDE, Bobigny (FR)

(73) Assignee: VALEO VISION, Bobigny (FR)

(21) Appl. No.: 18/866,795

(22) PCT Filed: May 26, 2023
(86) PCT No.: PCT/EP2023/064248

§ 371 Date: Nov. 18, 2024

(30) Foreign Application Priority Data
May 31, 2022 (FR) FR2205246

(51) Int. Cl. F21S 41/24; B60Q 1/00; B60Q 1/04; F21S 43/239; F21S 43/245

(52) U.S. Cl. CPC F21S 41/24; B60Q 1/0011; B60Q 1/04; F21S 43/239; F21S 43/245

(57) ABSTRACT

The invention relates to a luminous device, such as one for a motor vehicle. The luminous device including at least one lighting module suitable for projecting light rays in order to carry out a lighting function and also including a luminous module with a flexible guide sheet suitable for receiving light rays and for reflecting the light rays in a direction substantially normal to a surface of the flexible guide sheet, at least one light injection element suitable for receiving light and distributing the light in the flexible guide sheet and at least one light source suitable for injecting light into the light injection element. The luminous module is arranged such that the light rays from the lighting module pass through the flexible guide sheet, and the light source is activated when the lighting module is deactivated.

### TECHNICAL FIELD

The present invention relates to the field of luminous devices comprising one or more lighting modules, in particular for automotive vehicle headlamps. The invention applies in particular, but not exclusively, to the external appearance of such headlamps, in particular when the vehicle is driven during the day.

### BACKGROUND OF THE INVENTION

Luminous devices such as headlamps generally have a plurality of luminous functions performed by one or more modules. The following luminous functions are known in particular:
a lighting function of low beam (LB) type;
a lighting function of high beam (HB) type, which may be performed by the same lighting module as for the LB function, or by a separate module;
a daytime signaling function, also referred to as daytime running light (DRL), generally performed by a luminous module separate from the LB/HB module;
a signaling function of position light (PL) type, which may be performed by the luminous module which performs the DRL function, or by another luminous module.

The external appearance of the luminous device, which depends on the respective arrangement of the luminous modules, their number and their respective shapes, is referred to as the “signature”. The signature is particularly visible when all the modules of the luminous device are activated.

This signature may be perceived differently when driving at night and when driving during the day. This is because at night, the module(s) that perform the lighting functions such as LB and HB are visible to an outside observer. A complete signature is thus obtained.

However, during the day, these lighting functions are generally not activated, which results in one or more black areas in the signature of the luminous device. The signature of the luminous device is incomplete and different to the night signature for an observer located outside the vehicle.

### SUMMARY OF THE INVENTION

There is therefore a need to harmonize the signature of luminous devices for automotive vehicles between daytime driving and driving at night.

One known solution is to use liquid crystal films, such as PDLC (Polymer-Dispersed Liquid Crystal) films, to cover the dark areas corresponding to the lighting functions.

However, this solution has the following disadvantages:
it is sensitive to temperature, in particular negative temperatures, and does not work below −20° C.;
it is based on an organic pigment which absolutely must be isolated from the outside, because it is sensitive to humidity and light;
it is difficult to integrate into luminous devices, especially when the outer surface is not flat.

There is therefore a need to harmonize the signature of luminous devices for automotive vehicles, day and night, while providing a solution that is robust, easy to integrate and inexpensive.

The present invention aims to improve the situation.

To this end, a first aspect of the invention relates to a luminous device for an automotive vehicle, comprising at least one lighting module adapted to project light rays to perform an lighting function, and further comprising a luminous module comprising:
a flexible guide sheet adapted to receive light rays via at least one edge of said flexible guide sheet and to reflect the light rays in a direction substantially normal to a surface of the flexible guide sheet;
at least one light injection element adapted to receive light and to distribute the light in the flexible guide sheet;
at least one light source adapted to inject light into said at least one light injection element.

The flexible guide sheet is transparent, the luminous module is arranged such that the flexible guide sheet has the light rays from the lighting module passing through it, and the light source is activated when the lighting module is deactivated.

The use of a luminous module which is activated when the lighting module is deactivated makes it possible to harmonize the signature of the lighting device between situations of daytime driving and driving at night. Moreover, the luminous module is of the flexible guide sheet type, which is inexpensive, easy to manufacture, and easy to integrate, compared to prior art solutions. Lastly, such a solution is not very sensitive to environmental conditions such as humidity and temperature.

According to embodiments, the flexible guide sheet may be adapted to reflect the light rays according to at least one pattern etched in said flexible guide sheet, and a luminous area of the pattern may be arranged facing an optical projection surface of the lighting module.

It is thus easy to reproduce the signature of the luminous device by etching the flexible guide sheet, whatever the shape of the optical projection surface of the lighting module for which it is not desired to have a dark area when it is inactive.

According to embodiments, said at least one lighting module may be adapted to perform a low beam lighting function or a high beam lighting function.

These functions are usually deactivated during the day, and the modules that perform them are specifically adapted to create dark areas in the signature of the luminous device.

In addition, the lighting module may be adapted to perform a low beam lighting function and a high beam lighting function.

Thus, the same module may perform both functions, which limits the space required to perform these functions in the luminous device.

Alternatively, the luminous device may comprise a first lighting module adapted to perform a low beam lighting function and a second lighting module adapted to perform a high beam lighting function, said luminous module being arranged such that the flexible guide sheet has the light rays from the first lighting module or the second lighting module passing through it.

Thus, the luminous device may comprise two lighting modules, and the luminous module may be adapted to shield the dark areas associated with at least one of these two lighting modules.

In addition, the luminous module may be arranged such that the flexible guide sheet has the light rays from the first lighting module and the second lighting module passing through it.

Thus, a luminous module with a single flexible guide sheet can cover both lighting modules. To be specific, because they are flexible, and have a large surface area, with a low thickness, the luminous module can be easily integrated, being arranged opposite two lighting modules, without causing the luminous device to be very bulky.

According to an embodiment, the luminous module may comprise a single flexible guide sheet, a first pattern being etched in a first portion of the flexible guide sheet and a second pattern being etched in a second portion of the flexible guide sheet, a luminous area of the first pattern may be arranged facing a first optical projection surface of the first lighting module and a luminous area of the second pattern may be arranged facing a second optical projection surface of the second lighting module.

Thus, the bulk and the cost associated with the luminous module are reduced, with a single injection element and a source to illuminate two luminous areas facing two separate lighting modules. This embodiment is referred to as the second embodiment in the remainder of this description.

According to another embodiment, the luminous module may comprise a single flexible guide sheet, a first injection element and a second injection element, the first injection element may be arranged in such a way as to inject light into a first section of the edge of the flexible guide sheet and the second injection element may be arranged in such a way as to inject light into a second section of the edge of the flexible guide sheet, a first portion of the flexible guide sheet located facing the first section of the edge being etched according to a first pattern and a second portion of the flexible guide sheet located facing the second section of the edge being etched according to a second pattern, a luminous area of the first pattern may be arranged facing a first optical projection surface of the first lighting module and a luminous area of the second pattern may be arranged facing a second optical projection surface of the second lighting module.

This variant, referred to below as the third embodiment, advantageously makes it possible to selectively control the illumination of the first and second luminous areas. It is thus possible to illuminate only one of the two luminous areas, in particular when only one of the lighting modules is deactivated.

Alternatively, the luminous device may comprise a first luminous module and a second luminous module, the first luminous module comprising a first flexible guide sheet, a first injection element and a first light source and the second luminous module comprising a second flexible guide sheet, a second injection element and a second light source, the first luminous module may be arranged such that the first flexible guide sheet has the light rays from the first lighting module passing through it, and the second luminous module may be arranged such that the second flexible guide sheet has the light rays from the second lighting module passing through it.

Thus, one luminous module per lighting module may be provided, which facilitates the positioning of the luminous module and therefore its integration into the luminous device. This embodiment is referred to as the first embodiment in the description below.

According to embodiments, the luminous module may be arranged within a lens of an optical system of the lighting module.

Thus, the luminous module is mechanically protected while facilitating its positioning, and therefore its integration into the luminous device.

According to other embodiments of the invention, the luminous module may be arranged on an outer lens of the luminous device.

Luminous devices, such as headlamps, are subject to very significant space constraints. The space requirement is limited in this case by arranging the luminous module outside the luminous device.

According to embodiments, the illumination device may further comprise a signaling module adapted to perform a signaling function.

Thus, the illumination device may perform illumination and signaling functions, and may have a complex signature.

In addition, the signaling module may be adapted to perform a daytime running light function or a position light function.

These functions are usually necessary, and may thus be integrated with lighting functions in a luminous device.

Further in addition, the signaling module may be adapted to perform a daytime running light function and a position light function.

Thus, the same module is adapted to perform several signaling functions. In particular, such functions may vary only by the luminous intensity emitted, therefore by the power supply levels applied to the luminous sources of the signaling module.

According to an embodiment, the luminous device may further comprise a control unit adapted to activate said at least one light source when the lighting module is deactivated.

Thus, a control unit may be integrated into the luminous device, making it easier to operate the luminous module.

In addition, the control unit may also be adapted to activate and deactivate the lighting module as a function of control signals.

Thus, the control unit may control both the lighting module and the luminous module, making it easier to harmonize the signature between situations of daytime driving and driving at night.

Further in addition, the control unit may also be adapted to operate the signaling module.

Thus, the same control unit may operate all the modules of the lighting device. Centralized management of signaling and lighting functions is thus enabled.

In addition, the control unit may be adapted to operate the signaling module which is adapted to perform a daytime running light function, and, upon activation of the daytime running light function, the control unit may be configured to activate said at least one luminous source of the luminous module.

To be specific, since this signaling function is activated during the day, the luminous module is then activated when the lighting functions are deactivated. This makes it easier to harmonize the signature of the luminous device.

According to embodiments, each flexible guide sheet may comprise a film comprising microstructures, each pattern may be etched by ultraviolet printing of the microstructures of the film.

These microstructures make it possible to maintain a high level of transparency of the flexible guide sheet while projecting light in the luminous area when the luminous source is activated.

In addition, for each flexible guide sheet, a surface density of microstructures may decrease with the distance from the edge of the guide sheet into which the light is injected.

The homogeneity of a pattern projected by the flexible guide sheet is thus improved.

### BRIEF DESCRIPTION OF DRAWINGS

Other features and advantages of the invention will become apparent on examining the following detailed description, and the appended drawings, in which:

FIG. 1 depicts a luminous module of a luminous device for an automotive vehicle, according the invention;

FIG. 2 depicts an injection element of a luminous module according to an embodiment of the invention;

FIG. 3 depicts a luminous device for an automotive vehicle, according to embodiments of the invention;

FIG. 4 depicts a luminous module of a luminous device for an automotive vehicle, according to a first embodiment of the invention;

FIG. 5 depicts a luminous module of a luminous device for an automotive vehicle, according to a second embodiment of the invention; and

FIG. 6 depicts a luminous module of a luminous device for an automotive vehicle, according to a third embodiment of the invention.

### DETAILED DESCRIPTION OF THE INVENTION

The description concentrates on the features that differentiate the interior equipment and the luminous module from those known in the prior art.

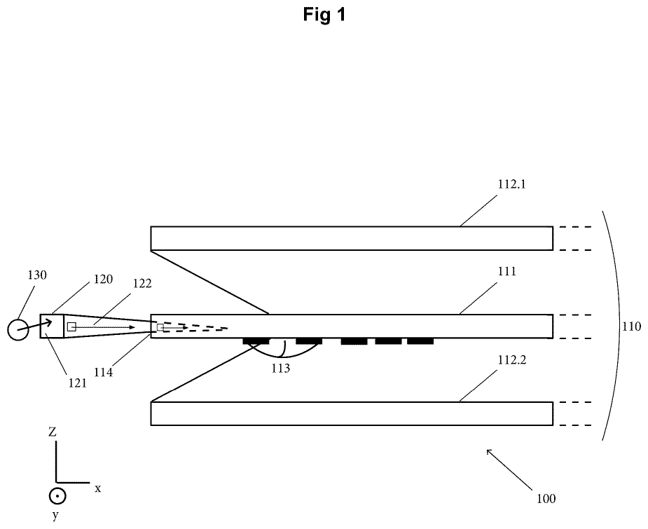

FIG. 1 shows a luminous module 100 of a luminous device for an automotive vehicle, according to the invention.

The luminous module 100 comprises a flexible guide sheet 110 adapted to receive light rays via an edge 114 and to reflect the light rays in a direction Z substantially normal to a surface of the flexible guide sheet which thus extends in a plane X-Y in FIG. 1.

Guide sheet is understood to mean an optical guide element of which one of the dimensions is much smaller than the other two dimensions in space, for example smaller by one or more orders of magnitude. As shown in FIG. 1, in this case it is a flexible guide sheet the thickness of which along the Z axis is at least two orders of magnitude smaller than its dimensions in the plane X-Y in which the flexible guide sheet 110 extends.

The flexible guide sheet 110 may comprise a flexible film 111 at its core comprising at least one edge 114, being adapted to guide the light rays in an overall direction X, and comprising a set of microstructures 113 adapted to reflect the light rays guided in the flexible film 111 outside the flexible guide sheet 110, in particular in one or more directions substantially along the axis Z.

The flexible film 111 may be a substrate film made of polycarbonate (PC), polymethyl methacrylate (PMMA), thermoplastic polyurethane (TUP) or polyethylene terephthalate (PET). The flexible film 111 may have a thickness, that is a dimension along the axis Z, of between 12 and 1000 micrometers. More specifically, the thickness of the flexible film 111 may be between 50 and 1000 micrometers, for example between 200 and 500 micrometers. Alternatively, it is the flexible guide sheet 110 which has a thickness of between 200 and 1000 micrometers.

The abovementioned materials, combined with a low thickness as described above, make it possible to obtain a flexible film 111. Other materials may be considered for the composition of the flexible film 111. However, it is preferable according to the invention to provide deformable, transparent materials.

A thin coating of microstructures 113 may be applied to one of the faces of the flexible film 111, or be integrated in the flexible film 111. The microstructure coating 113 may in particular have a thickness along the axis Z of less than 20 micrometers.

These microstructures 113 may generally take the form of a bump, on which the light rays are reflected in a direction substantially along the axis Z. These microstructures 113 may be adapted such that the light rays exiting the flexible film 111 form a pattern. To this end, the microstructures 113 may be etched by ultraviolet printing, according to the desired pattern.

Microstructures 113 are structures, or irregularities of the flexible film, with dimensions of under a few micrometers. Microstructures thus also cover nanometric structures. Such sizes of microstructures 113 make it possible to ensure high transparency of the flexible film 111. In particular, a transparency of the order of 97% may be obtained in practice by the use of microstructures 113. Alternatively, the flexible guide sheet may be semi-transparent or opaque.

Advantageously, the microstructures 113 may be distributed along the axis X such that a linear density of microstructures 113 is proportional to the distance from the edge 114 via which the light rays injected by the injection element 120 are received. In other words, the further the microstructures 113 are from the edge 114, the more densely they are grouped together. Such a distribution advantageously makes it possible to ensure a homogeneous distribution along the axis X of the luminous intensity of the pattern emitted by the flexible guide sheet 110.

The flexible guide sheet 110 may further comprise one or two optional protective layers 112.1 and 112.2, which make it possible to mechanically protect the flexible film 111. Furthermore, at least one of the protective layers 112.1 and 112.2 may comprise an anti-UV treatment, making it possible to protect the flexible film against UV rays, once the microstructures 113 have been etched. Without such UV protection, the pattern projected by the flexible guide sheet 110 is likely to deteriorate over time, particularly when exposed to sunlight.

The flexible film 111 and the protective layers 112.1 and 112.2 are shown spaced apart in FIG. 1, purely for illustrative purposes. It will be understood, however, that the protective layers 112.1 and 112.2 may be attached to the flexible film, in particular by lamination.

Since the guide sheet 110 is flexible, it is not necessarily included in a plane but may be curved, depending on the position in which it is placed and the mechanical constraints applied to it.

The luminous module 100 shown in FIG. 1 also comprises a light injection element 120, also referred to as a light bar, because it extends longitudinally in a direction Y, and adapted to inject light in a direction normal to its longitudinal direction, for example along the axis X when it is arranged in the manner shown in FIG. 1.

The light injection element 120 has a rectangular or square section in FIG. 1. However, the light injection element 120 may have a round, oval, or polygonal section.

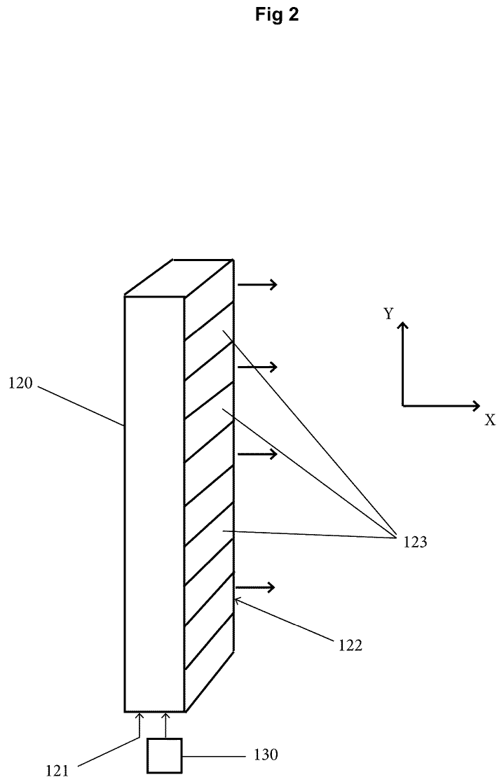

Thus, the light injection element 120 comprises an output surface 122 extending in the longitudinal direction and adapted to inject light in a direction substantially normal to the output surface 122. The light injection element 120 further comprises an input surface 121, at one end of the light injection element 120, adapted to receive light rays from a light source 130, and the light injection element 120 is adapted to guide the light longitudinally along the axis Y, distributing it over the output surface 122. The distribution of light by the output surface 122 will be understood more clearly from the description of FIG. 2.

No restriction is imposed on the light source 130. The light source 130 may be adapted to generate light in a wavelength range. Such a range may be centered around a visible color, in order to generate colored light, for example blue, red or green. Alternatively, the light source 130 may emit light rays across the entire range of wavelengths visible to the human eye, in such a way as to generate white light. A very narrow wavelength range may be produced by a laser type light source 130.

The light source 130 may be adapted to generate light in at least two distinct wavelength ranges, for example corresponding to two distinct colors. It may for example be a light-emitting source of LED type for example, having the advantage of small size, low energy consumption and of not heating up very much, producing two different colours of light, adapted to be controlled by a control element (not shown). It may in particular be an RGB type diode, adapted to produce red, green and blue light. Thus, the luminous module according to the first embodiment may comprise a flexible guide sheet 110, an injection element 120 and a light source 130 adapted to generate light in at least two distinct wavelength ranges.

The light source 130 may be controlled by a control element (not shown but described below).

Alternatively, the light source 130 is not arranged directly opposite the input surface 121 of the injection element 120, but the luminous module 100 further comprises an optical fiber placed between the source 130 and the injection element 120, which makes it possible to move the source 130 away from the assembly formed by the injection element 120 and the flexible guide sheet 110.

FIG. 2 shows an injection element 120 of a luminous module according to embodiments of the invention.

The injection element 120 may comprise a plurality of injection guides 123 adapted to receive light from the source 130 via the input surface 121 and to guide the light to a longitudinal position on the output surface 122, the longitudinal positions of the light guides being distinct in such a way as to distribute the light to at least several longitudinal positions on the output surface 122.

This makes it possible to inject light at different longitudinal positions along the axis Y on the edge 114. Each longitudinal position on the edge 114 may correspond to a guide line of the flexible film 111, adapted to guide the light along the axis X along such a guide line.

Such a combination of a flexible guide sheet 110, an injection element 120 and a source 130 thus makes it possible to project light in the direction Z via a flexible, transparent or semi-transparent surface, with good surface homogeneity and according to a given pattern.

In practice, such a luminous module may make it possible to emit a pattern having luminous areas with a brightness of between 100 and 1000 candelas per square meter, with a light extraction efficiency that may range between 25% and 80%.

Details on the structure and arrangement of these elements 110, 120 and 130 are described further in the international patent application published under number WO2011130715A2.

A luminous module of a luminous device for a vehicle according to the invention comprises:
a guide sheet, such as the flexible guide sheet 110 shown in FIG. 1, the assembly being adapted to reflect light according to at least one pattern;
at least one light injection element, such as the injection element 120 described with reference to FIGS. 1 and 2; and
at least one light source, such as the light source 130 described above with reference to FIG. 1, adapted to inject light into said at least one injection element.

“Pattern” means any predefined spatial distribution of the luminous intensity emitted by the luminous module. In particular, reference is made here to a two-dimensional or one-dimensional pattern. A pattern may thus comprise a two-dimensional shape or symbol obtained by contrast between the luminous intensities of different positions in the plane X-Y of the flexible guide sheet 110. The pattern may also include several shapes or symbols. Alternatively, a pattern covers a predefined, or intentional, spatial distribution of luminous intensity that does not cause any general shape to appear, such as a distribution resulting in a cloud of luminous dots. In the context of the present invention, a pattern is formed by injecting light into an injection element which is arranged relative to a flexible guide sheet in such a way as to form the pattern on the flexible guide sheet. A flexible guide sheet is thus adapted to project light according to at least one pattern, and a pattern may correspond to at least one shape or symbol. A flexible guide sheet may also project light according to at least two patterns, when the flexible guide sheet is combined with several injection elements. The shapes or symbols may be produced by contrast between luminous areas, through which light rays are emitted, and dark areas, through which no light rays are emitted.

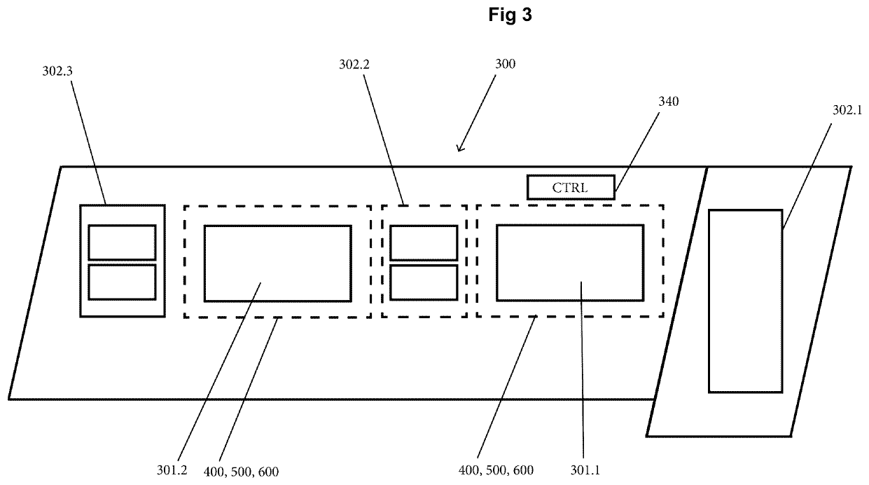

FIG. 3 depicts a luminous device 300 according to embodiments of the invention.

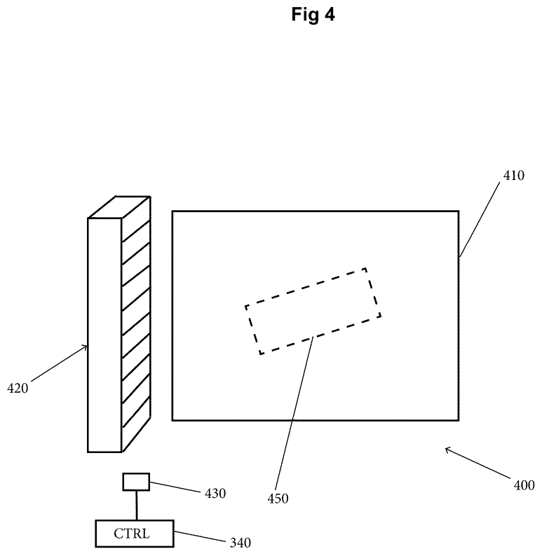

The luminous device 300 according to the invention comprises at least one luminous module as described above, and embodiments of which will be described in FIGS. 4, 5 and 6, which is referenced 400, 500, 600 in FIG. 3. As will be become clear, the luminous device 300 may comprise several luminous modules.

The luminous device 300 further comprises an lighting module 301.1; 301.2 adapted to project light rays toward the outside of the luminous device 300 so as to perform at least one lighting function. This lighting function may for example be a low beam (LB) function or a high beam (HB) function. Alternatively, the lighting module 301.1; 301.2 is controllable, for example by a control element 340, and may be controlled to perform two different lighting functions, such as the LB and HB functions. No restriction is imposed on the technology associated with the lighting module. No restriction is imposed in particular on the light source of the lighting module 301.1; 301.2, which may be a source comprising a luminous element or several luminous elements, such as one or more LEDs. The light source of the lighting module may be an array source, comprising an array of micro-mirrors of DMD type, an array of LEDs, or any other array source.

The luminous device 300 may optionally comprise one or more signaling modules 302.1; 302.2 and 302.3, adapted to project light rays toward the outside of the luminous device so as to perform a signaling function. The signaling module may, for example, be adapted to perform a position light PL function or a daytime running light DRL function. In addition, the signaling module may be adapted to perform both position light PL and daytime running light DRL functions, with only the luminous intensity emitted by the signaling module being variable between the two functions. Such a variation in luminous intensity may be obtained by activating/deactivating luminous sources of the signaling module, or by supplying power to the luminous source(s) in pulse width modulation, by varying the duty cycle.

The luminous device 300 for an automotive vehicle is preferably an automotive vehicle headlamp, for example an automotive vehicle front headlamp.

No restriction is imposed on the number of lighting modules, luminous modules and signaling modules that the luminous device 300 comprises, nor on their respective shapes and arrangements, which make up the signature of the luminous device 300. As described above, a luminous device according to the invention comprises:
at least one lighting module;
at least one luminous module as described above;
optionally, at least one signaling module.

In the particular example shown in FIG. 3, the illumination device 300 comprises:
a first lighting module 301.1 and a second lighting module 301.2. For example, the first lighting module 301.1 may perform a low beam LB lighting function while the second lighting module 301.2 may perform a high beam HB lighting function;
a first signaling module 302.1, in two parts, upper and lower, a second signaling module 302.2, in two parts, upper and lower, and a third signaling module 302.3, in two parts, upper and lower. Each signaling module 302.1; 302.2 or 302.3 is adapted to project light rays toward the outside of the luminous device so as to perform a signaling function. Each signaling module may perform its own signaling function, or alternatively, the signaling modules 302.1, 302.2 and 302.3 may perform the same signaling function(s), and thus be controlled together, for example by the control element 340;
a luminous module 400, 500, 600, or two luminous modules 400, 500, 600, depending on the embodiment in question.

The control element 340 may centralize the control of all the modules, in other words the lighting module(s), the luminous module(s), and the signaling module(s). The control element 340 may control the activation or deactivation of each module as a function of control signals, received for example by a central control module of the automotive vehicle, such as an electronic control unit (ECU).

The control element 340 may comprise a processor configured to communicate unidirectionally or bidirectionally, via one or more buses or via a wired connection, with a memory such as a random access memory (RAM) or a read only memory (ROM) or any other type of memory (flash, EEPROM, etc.). Alternatively, the memory comprises several memories of the aforementioned types. Preferably, the memory is non-volatile memory. The processor is adapted to execute instructions, stored in the memory, and control the modules of the luminous device 300 as a function of control signals. Alternatively, the processor may be replaced by a microcontroller designed and configured to implement control of the modules as a function of the control signals received.

Alternatively, each module comprises a dedicated control element.

FIG. 4 shows a luminous module 400 of a luminous device according to a first embodiment of the invention.

The luminous module 400 comprises a flexible guide sheet 410, an injection element 420 and a light source 430, similar to the flexible guide sheet 110, the injection element 120 and the light source 130 described above.

The flexible guide sheet 410 is etched according to a pattern comprising a luminous area 450, adapted to reflect the light rays injected by the injection element 420, following activation of the light source 430.

The luminous area 450 is arranged facing an optical projection surface of an lighting module. The luminous area 450 may also be shaped to be superimposed with the optical projection surface of the lighting module. The luminous area 450 may thus have the same shape as a projection, in the plane of the flexible guide sheet, of the optical projection surface of the lighting module.

This makes it possible to illuminate the luminous area 450 by activating the source 430, when the lighting module, on which the luminous module 400 is placed, is deactivated. Thus, an outside observer does not see a dark area in the region of the lighting module when it is deactivated, as is generally the case during the day. The invention thus makes it possible to homogenize the signature of the luminous device comprising a luminous module 400 arranged on an lighting module.

The luminous module 400 may for example be used in the example of FIG. 3, being arranged facing the lighting module 301.1 or the lighting module 301.2. Alternatively, the luminous device 300 comprises a first luminous module identical to the luminous module 400 arranged facing the first lighting module 301.1, and a second luminous module identical to the luminous module 400 arranged facing the second lighting module 301.2.

Thus, several luminous modules 400 may be advantageously used in a luminous device comprising several lighting modules. When the lighting modules have optical surfaces of different shapes, the luminous areas 450 of the luminous modules 400 vary in such a way as to be identical to the respective optical surfaces of the lighting modules that they cover. This makes it possible to homogenize complex signatures between the periods of day and night.

Advantageously, the light source 430 is controlled by the control element 340 described above. The control element 340 may also control the lighting module opposite which the luminous module 400 is placed. Thus, the control element 340 is adapted to activate the light source 430 when it deactivates the lighting module.

In the example of FIG. 3, the control element 340 may activate a first luminous module 400 arranged facing the first lighting module 301.1, when the first lighting module 301.1 is deactivated, and the control element 340 may activate a second luminous module 400 arranged facing the second lighting module 301.2, when the second lighting module 301.1 is deactivated.

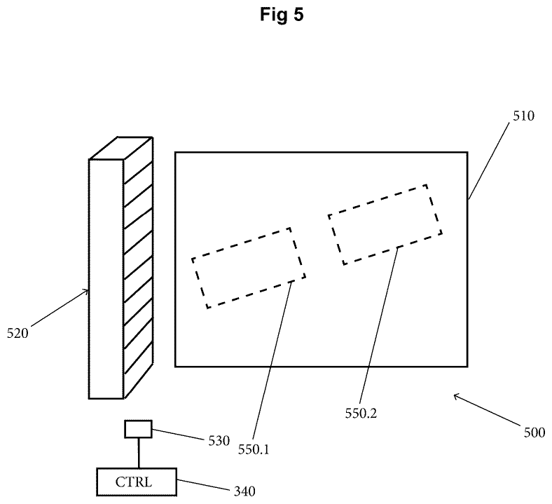

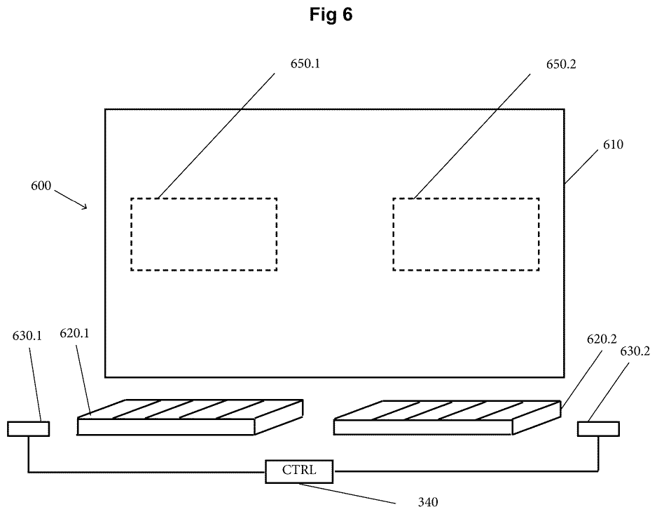

Alternatively, with reference to FIGS. 5 and 6, two embodiments are presented in which a single luminous module 500 or 600 may be arranged facing at least two lighting modules of a luminous device.

FIG. 5 depicts a luminous module 500 of an illumination device according to a second embodiment of the invention.

According to the second embodiment, the luminous module 500 comprises a flexible guide sheet 510, an injection element 520 and a light source 530, similar to the flexible guide sheet 110, the injection element 120 and the light source 130 described above.

The flexible guide sheet 510 is etched according to a pattern comprising a first luminous area 550.1 and a second luminous area 550.2, adapted to reflect the light rays injected by the injection element 520, following activation of the light source 530.

The first luminous area 550.1 is arranged facing a first optical projection surface of a first lighting module and the second luminous area 550.2 is arranged facing a second optical projection surface of a second lighting module. The first and second luminous areas 550.1 and 550.2 may also be shaped to be superimposed with the optical projection surfaces of the first and second lighting modules. The first and second luminous areas 550.1 and 550.2 may thus have the same shapes as projections, in the plane of the flexible guide sheet 510, of the optical projection surfaces of the lighting modules.

This makes it possible to illuminate the luminous areas 550.1 and 550.2 by activating the source 530, when the first lighting module and/or the second lighting module, on which the luminous module 500 is placed, are deactivated. Thus, an outside observer does not see a dark area in the region of the lighting modules when at least one of the lighting modules is deactivated, as is generally the case during the day. The invention thus makes it possible to homogenize the signature of the luminous device comprising a luminous module 500 arranged on several lighting modules, using a single flexible guide sheet 510, a single injection element 520 and a single light source 530. This reduces the bulk and costs.

The luminous module 500 may for example be used in the example of FIG. 3, being arranged facing the lighting modules 301.1 and 301.2.

Thus, a single luminous module 500 may be advantageously used in a luminous device comprising several lighting modules. When the lighting modules have optical surfaces of different shapes, the luminous areas 550.1 and 550.2 have different shapes in such a way as to be identical to the respective optical surfaces of the lighting modules that they cover. This makes it possible to homogenize complex signatures between the periods of day and night.

Advantageously, the light source 530 is controlled by the control element 340 described above. The control element 340 may also control the lighting modules opposite which the luminous module 500 is placed. Thus, the control element 340 is adapted to activate the light source 530 when it deactivates at least one of the lighting modules of the luminous device.

In the example of FIG. 3, the control element 340 may activate the luminous module 500 arranged facing the first lighting module 301.1 and the second lighting module 301.2, when the first lighting module 301.1 is deactivated, when the second lighting module 301.2 is deactivated or when the first and second lighting modules 301.1 and 301.2 are deactivated.

FIG. 6 depicts a luminous module 600 of an illumination device according to a third embodiment of the invention.

According to the third embodiment, the luminous module 600 comprises a flexible guide sheet 610, a first injection element 620.1, a second injection element 620.2, a first light source 630.1 and a second light source 630.2, similar to the flexible guide sheet 110, the injection element 120 and the light source 130 described above.

The flexible guide sheet 610 is etched according to a pattern comprising a first luminous area 650.1 located in a first portion of the flexible guide sheet 610, and a second luminous area 650.2 located in a second portion of the flexible guide sheet 610. Alternatively, it may be considered that a first pattern is etched in the first portion of the flexible guide sheet 610, comprising the first luminous area 650.1, and that a second pattern is etched in the second portion of the flexible guide sheet 610, comprising the second luminous area 650.2.

The first light source 630.1 is adapted to inject light into the first injection element 620.1 which is itself adapted to inject, or distribute, the light into the first portion of the flexible guide sheet so as to illuminate the first luminous area 650.1. To this end, the first injection element 620.1 is arranged facing a first section of the edge 114 of the flexible guide sheet 610.

The second light source 630.2 is adapted to inject light into the second injection element 620.2 which is itself adapted to inject, or distribute, the light into the second portion of the flexible guide sheet 610 so as to illuminate the second luminous area 650.2. To this end, the second injection element 620.2 is arranged facing a second section of the edge of the flexible guide sheet 610, distinct from the first section.

The first luminous area 650.1 is arranged facing a first optical projection surface of a first lighting module and the second luminous area 650.2 is arranged facing a second optical projection surface of a second lighting module. The first and second luminous areas 650.1 and 650.2 may also be shaped to be superimposed with the optical projection surfaces of the first and second lighting modules. The first and second luminous areas 650.1 and 650.2 may thus have the same shapes as projections, in the plane of the flexible guide sheet 610, of the optical projection surfaces of the lighting modules.

This makes it possible to illuminate the luminous areas 650.1 and 650.2 by selective activation of the sources 630.1 and 630.2. When the first lighting module is deactivated, the first light source 630.1 may be activated. When the second lighting module is deactivated, the second light source 630.2 may be activated. Thus, the sources 630.1 and 630.2 may be controlled separately, for example by the control element 340.

Alternatively, the control element 340 simultaneously activates the sources 630.1 and 630.2, and the first and second luminous areas 650.1 and 650.2 are thus illuminated when at least one of the first and second lighting modules is deactivated.

Thus, an outside observer does not see a dark area in the region of the lighting modules when at least one of the lighting modules is deactivated, as is generally the case during the day. The invention thus makes it possible to homogenize the signature of the luminous device comprising a luminous module 600 arranged on several lighting modules, using a single flexible guide sheet 610, by making it possible to selectively illuminate the first and second luminous areas 650.1 and 650.2.

The luminous module 600 may for example be used in the example of FIG. 3, being arranged facing the lighting modules 301.1 and 301.2.

Thus, a single luminous module 600 may be advantageously used in a luminous device comprising several lighting modules. When the lighting modules have optical projection surfaces of different shapes, the luminous areas 650.1 and 650.2 have different shapes in such a way as to be identical to the respective optical surfaces of the lighting modules that they cover. This makes it possible to harmonize complex signatures between the periods of day and night.

Advantageously, the light sources 630.1 and 630.2 are controlled by the control element 340 described above. The control element 340 may also control the lighting modules opposite which the luminous module 600 is placed. Thus, the control element 340 is adapted to selectively activate the light sources 630.1 and 630.2 when it deactivates at least one of the lighting modules of the luminous device.

In the example of FIG. 3, the control element 340 may illuminate the first luminous area 650.1 arranged facing the first lighting module 301.1 when the first lighting module 301.1 is deactivated, and may illuminate the second luminous area 650.2 arranged facing the second lighting module 301.2 when the second lighting module 301.2 is deactivated.

In the embodiments described above, the luminous area(s) may be controlled as a function of the activation of one of the signaling modules. The control element 340 may in particular control the luminous module(s), the lighting module(s), but also one or more signaling modules, like those shown in FIG. 3. In particular, the control element 340 may advantageously activate the light source(s) of the luminous module 400, 500 or 600 when the daytime running light DRL function is activated on at least one of the signaling modules responsible for this signaling function. Since this function is activated during the day, it is thus ensured that the light sources of the luminous modules are activated during the day, which makes it possible to homogenize the signature of the luminous device 300 between situations of daytime driving and driving at night.

A luminous area is a portion of the flexible guide sheet pattern adapted to reflect light rays guided in the flexible guide sheet to the outside of the flexible guide sheet. The luminous intensity within a luminous area may vary. Luminous areas and dark areas can thus be distinguished in a pattern. Advantageously, according to the invention, the luminous areas are placed facing optical surfaces of lighting modules, and may have the same shape as these optical surfaces.

The present invention is not limited to the embodiments described above by way of examples; it extends to other variants.

What is claimed is:

1. A luminous device for an automotive vehicle, comprising at least one lighting module adapted to project light rays to perform a lighting function, and a luminous module including:
a flexible guide sheet adapted to receive light rays via at least one edge of the flexible guide sheet and to reflect the light rays in a direction substantially normal to a surface of the flexible guide sheet;
at least one light injection element adapted to receive light and to distribute the light in the flexible guide sheet;
at least one light source adapted to inject light into the at least one light injection element;
wherein the flexible guide sheet is transparent, wherein the luminous module is arranged such that the flexible guide sheet has the light rays from the lighting module passing through it, and wherein the light source is activated when the lighting module is deactivated.

2. The luminous device as claimed in claim 1, wherein the flexible guide sheet is adapted to reflect the light rays according to at least one pattern etched in the flexible guide sheet, and wherein a luminous area of the pattern is arranged facing an optical projection surface of the lighting module.

3. The luminous device as claimed in claim 1, wherein the at least one lighting module is adapted to perform a low beam lighting function or a high beam lighting function.

4. The luminous device as claimed in claim 3, wherein the lighting module is adapted to perform a low beam lighting function and a high beam lighting function.

5. The luminous device as claimed in claim 3, including a first lighting module adapted to perform a low beam lighting function and a second lighting module adapted to perform a high beam lighting function, the luminous module being arranged such that the flexible guide sheet has the light rays from the first lighting module or the second lighting module passing through it.

6. The luminous device as claimed in claim 5, wherein the luminous module is arranged such that the flexible guide sheet has the light rays from the first lighting module and the second lighting module passing through it.

7. The luminous device as claimed in claim 6, wherein the luminous module includes a single flexible guide sheet, a first pattern being etched in a first portion of the flexible guide sheet and a second pattern being etched in a second portion of the flexible guide sheet, wherein a luminous area of the first pattern is arranged facing a first optical projection surface of the first lighting module and wherein a luminous area of the second pattern is arranged facing a second optical projection surface of the second lighting module.

8. The luminous device as claimed in claim 6, wherein the luminous module includes a single flexible guide sheet, a first injection element and a second injection element, wherein the first injection element is arranged in such a way as to inject light into a first section of the edge of the flexible guide sheet and wherein the second injection element is arranged in such a way as to inject light into a second section of the edge of the flexible guide sheet, a first portion of the flexible guide sheet located facing the first section of the edge being etched according to a first pattern and a second portion of the flexible guide sheet located facing the second section of the edge being etched according to a second pattern, wherein a luminous area of the first pattern is arranged facing a first optical projection surface of the first lighting module and wherein a luminous area of the second pattern is arranged facing a second optical projection surface of the second lighting module.

9. The luminous device as claimed in claim 5, including a first luminous module and a second luminous module, the first luminous module comprising including a first flexible guide sheet, a first injection element and a first light source and the second luminous module including a second flexible guide sheet, a second injection element and a second light source, wherein the first luminous module is arranged such that the first flexible guide sheet has the light rays from the first lighting module passing through it, and the second luminous module is arranged such that the second flexible guide sheet has the light rays from the second lighting module passing through it.

10. The luminous device as claimed in claim 1, wherein the luminous module is arranged within a lens of an optical system of the lighting module.

11. The luminous device as claimed in claim 1, wherein the luminous module is arranged on an outer lens of the luminous device.

12. The luminous device as claimed in claim 1, further comprising a signaling module adapted to perform a signaling function.

13. The luminous device as claimed in claim 12, wherein the signaling module is adapted to perform a daytime running light function or a position light function.

14. The luminous device as claimed in claim 13, wherein the signaling module is adapted to perform a daytime running light function and a position light function.

15. The luminous device as claimed in claim 1, further comprising a control unit adapted to activate the at least one light source when the lighting module is deactivated.

16. The luminous device as claimed in claim 15, wherein the control unit is also adapted to activate and deactivate the lighting module as a function of control signals.

17. The luminous device as claimed in claim 15, wherein the control unit is also adapted to operate a signalling module.

18. The luminous device as claimed in claim 17, wherein the control unit is adapted to operate the signalling module which is adapted to perform a daytime running light function, and wherein, upon activation of the daytime running light function, the control unit is configured to activate the at least one luminous source.

19. The luminous device as claimed in claim 1, wherein each flexible guide sheet includes a film including microstructures, wherein each pattern is etched by ultraviolet printing of the microstructures of the film.

20. The luminous device as claimed in claim 19, wherein, for each flexible guide sheet, a surface density of microstructures decreases with the distance from the edge of the guide sheet into which the light is injected.
